(19) United States
(12) Patent Application Publication
(10) Pub. No.: US 2025/0088293 A1
(43) Pub. Date: Mar. 13, 2025

(54) CUSTOMER PREMISE EQUIPMENT (CPE) WAN MANAGEMENT PROTOCOL (CWMP) CELLULAR DIAGNOSTICS

(71) Applicant: Rakuten Mobile, Inc., Tokyo (JP)

(72) Inventor: Richard LEA, Tokyo (JP)

(21) Appl. No.: 18/560,399

(22) PCT Filed: Aug. 31, 2023
(86) PCT No.: PCT/US2023/031750

§ 371 Date: Nov. 13, 2023

(51) Int. Cl. H04B 17/318; H04W 48/20

(52) U.S. Cl. CPC H04B 17/328; H04W 48/20

(57) ABSTRACT

Cellular Diagnostics is implemented using a Device and Management Server. A Device having a Client conducts a quality measurement procedure to obtain measurement results associated with radio communication, wherein the Device telecommunicates with at least one base station. The measurement results are configured into parameters of a Cellular Diagnostic Data Model by the Device. The parameters of the Cellular Diagnostic Data Model are provided to a Management Server. The Device is able to be a Customer Premise Equipment (CPE) and the Management Server is able to be an Auto-Configuration Server (ACS) The client of the Device is able to be a CPE WAN Management Protocol (CWMP) Client and the measurement results are able to be communicated to the ACS via a TR-069 protocol.

### TECHNICAL FIELD

This description relates to Customer Premise Equipment (CPE) WAN Management Protocol (CWMP) Cellular Diagnostics, and method of using the same.

### BACKGROUND

The International Telecommunication Union Radio communication sector (ITU-R) performs a standardization work of International Mobile Telecommunication (IMT)-Advanced, which is a next-generation mobile communication system after 3rd generation systems. 3rd Generation Partnership Project (3GPP) is a system standards organization that includes a group of telecommunications associations for developing mobile communications systems. 3GPP standards meet the conditions of the IMT-Advanced specifications for LTE-Advanced by enhancing Long Term Evolution (LTE).

In a mobile communication system, terminals support measurement reporting for operations, such as handovers and the like. For example, a terminal or mobile phone is able to measure a quality for a serving cell providing a current service and a quality for a neighbor cell. The terminal is able to report a measurement result to a network at an appropriate time or in response to a triggering event or request, and the network provides optimal mobility to the terminal based on the report of the measurement results through, for example, handover, and the like.

The Radio Resource Control (RRC) protocol is used in UMTS, LTE and 5G interface, wherein RRC provides a layer 3 (Network Layer) protocol for the signaling exchanged between the mobile and the evolved Node Base station (eNB) over the LTE-Uu radio interface. RRC is specified by 3GPP in TS 25.331 for UMTS, in TS 36.331 for LTE and in TS 38.331 for 5G New Radio. RRC messages are generally transported via the PDCP-Protocol.

The RRC Protocol is used for sending UE a request for a measurement report by a base station, and for reporting of the measurement report by the UE to the base station to inform the network of quality measurements. RRC Protocol enables the network to monitor and adapt to the changing radio environment. Mobile devices measure various parameters, such as signal strength, and neighbor cell information, and report these measurements. Measurements carried out on the serving cell and on the neighbor cells are used for the selection of the cell and for the handover. The intra-frequency measurement, which is able to be used for mobility, is configured when UE connects to a base station.

The configuration of measurements performed by the mobile terminal is able to be triggered by a base station, such as an eNB, in radio resource control (RRC) messages. Thus, the quality measurement procedure enables a base station to share link quality measurements between the UE and ambient cells. The RRC measurement reports are also able to include requested measurements of block error rate, transmit power and other UE-based parameters. The UE learns the requested information using a measurement configuration. However, there is difficulty in sharing of the Measuring Report in other contexts due to the original closed nature within 3GPP, including chipset, device, and cellular base stations.

The 3GPP specified measuring result is not specified for sharing the measuring results with TR-069 components. CPE WAN Management Protocol (CWMP) TR-069 was designed by the Broadband Forum (BBF) to standardize remote management and provisioning of Customer-Premises Equipment (CPE) connected to an Internet protocol network. TR-069 enables remote and safe configuration of CPEs. Configuration is managed by a central management server, which is referred to as an Auto-Configuration Server (ACS). A Quality Measurement Procedure has now been specified in the context of 3GPP, where a connection quality measurement is able to be made accessible and visible using the TR-069. However, due to lack of support to enable use of the measurement result across different protocols, TR-069 components cannot take advantage of the 3GPP specified measurements. Further, there are no standardized scheme for configuring and sharing such measurement reports with a base station by a terminal across external context.

### SUMMARY

In at least embodiment, a method for performing cellular diagnostics includes conducting, by a device, a quality measurement procedure to obtain measurement results associated with radio communication, wherein the device telecommunicates with at least one base station, configuring the measurement results into parameters of a Cellular Diagnostic Data Model; and providing, by the device, the parameters of the Cellular Diagnostic Data Model to a management server.

In at least one embodiment, a device, includes a memory storing computer-readable instructions, and a processor connected to the memory, wherein the processor is configured to execute the computer-readable instructions to perform operations to conduct a quality measurement procedure to obtain measurement results associated with radio communication, wherein the processor telecommunicates with at least one base station, configure the measurement results into parameters of a Cellular Diagnostic Data Model, and provide the parameters of the Cellular Diagnostic Data Model to a management server.

In at least one embodiment, a non-transitory computer-readable media having computer-readable instructions stored thereon, which when executed by a processor causes the processor to perform operations including conducting, by a device, a quality measurement procedure to obtain measurement results associated with radio communication, wherein the device telecommunicates with at least one base station, configuring the measurement results into parameters of a Cellular Diagnostic Data Model, and providing, by the device, the parameters of the Cellular Diagnostic Data Model to a management server.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 is an architecture for providing cellular diagnostics according to at least one embodiment.

FIG. 2 illustrates a Cellular Diagnostics Data Model defining parameters for the cellular diagnostics measurement results according to at least one embodiment.

FIG. 3 illustrates the cellular diagnostics mechanism triggered by change of attachment of a device to a base station according to at least one embodiment.

FIG. 4 illustrates a Device executing cellular diagnostics to transfer 3GPP measurement reports into a TR-069 communication model for consumption by a Management Server according to at least one embodiment.

FIG. 5 shows handover handling between two carriers according to at least one embodiment.

FIG. 6 is a flowchart of a method for performing cellular diagnostics according to at least one embodiment.

FIG. 7 is a flowchart of a method for a Device to respond to Requests and Commands from a Management Server according to at least one embodiment.

FIG. 8 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data-streaming or signaling-streaming. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, data-streaming or signaling-streaming from UE.

In at least one embodiment, a method for performing cellular diagnostics includes conducting, by a device, a quality measurement procedure to obtain measurement results associated with radio communication, wherein the device telecommunicates with at least one base station, configuring the measurement results into parameters of a Cellular Diagnostic Data Model; and providing, by the device, the parameters of the Cellular Diagnostic Data Model to a management server.

Embodiments described herein provide method that provides one or more advantages. According to at least one embodiment, modules featured in 3GPP specified measuring reports are able to be used by a Device to communicate via a common protocol with a Management Server. For example, according to one embodiment, Customer Premise Equipment (CPE) WAN Management Protocol (CWMP) is able to be used for Cellular Diagnostics by reusing existing modules featured in 3GPP specified measuring reports in TR-069 CWMP and Auto-Configuration Server (ACS). A carrier is able to make full usage of cellular environment information (e.g., representation from a Cell ID set) to calculate location of a Device and monitor movement of a Device. Cellular Diagnostics according to at least one embodiment reduces additional cost and additional battery usage by traditional GPS or similar components used for location features because location is able to be determined based on measurement results of predetermined parameters. For example, a Device, including Mobile Phones, Wi-Fi Routers, and the like, are able to be implemented as a TR-069 Component. A Cellular Diagnostics method according to at least one embodiment addresses the radio communication network connectivity issue between a base station and Devices (e.g., CPEs, mobile phones, routers and the like) by creating a Cellular Diagnostics Data Model (including that obtained under 3GPP technical spec) and enabling the measurement results configured according to the Cellular Diagnostics Data Model to be utilized under a predetermined framework. In at least one embodiment, the framework is the CWMP framework, which includes CPE and ACS. Thus, the sharing of data indicating the radio communication quality between base stations and Devices enables trouble-shooting issues at the core network by the management server, e.g., ACS. A Cellular Diagnostics method according to at least one embodiment completes the missing diagnostics feature definition for a cellular context in TR-069 enabled components, along with a corresponding data scheme or Cellular Diagnostics Data Model that is compatible with TR-181 and 3GPP. The 3GPP measurement results are thus able to be used in a location calculation business practice.

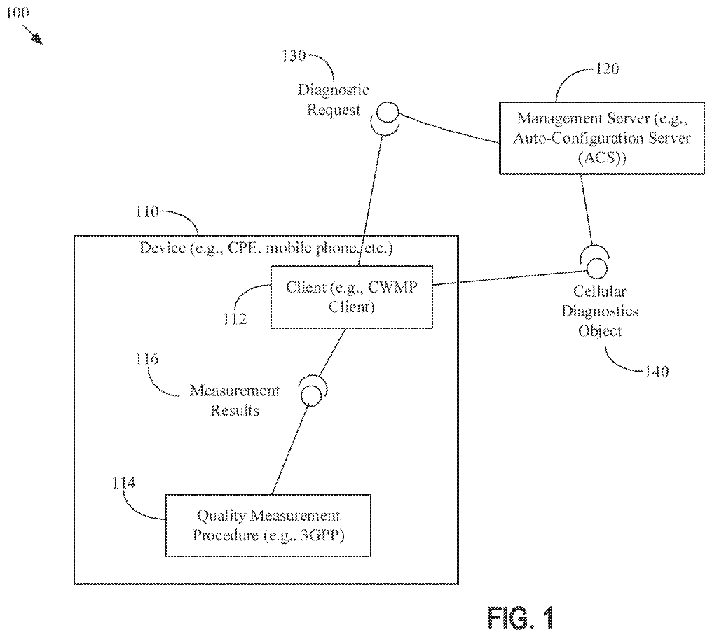

FIG. 1 is an architecture for providing cellular diagnostics 100 according to at least one embodiment.

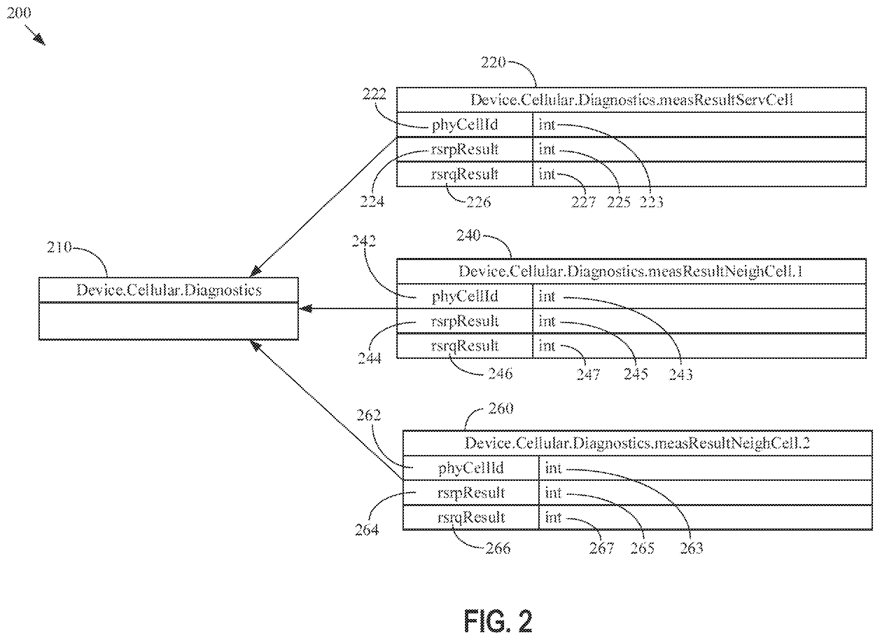

In FIG. 1, a Device 110, such as Customer-Premises Equipment (CPE), mobile phone, and the like, communicates with a Management Server 120, such as an Auto-Configuration Server (ACS). The Device 110 is able to implement a Client 112, such as a CPE WAN Management Protocol (CWMP) Client. The Client 112 communicates with the Management Server 120 using a specific communication protocol for providing the parameters of a Cellular Diagnostics Data Model as described in FIG. 2 below. As described herein, a Device 110 refers to an end user system including private network elements connecting the applications to a network, wherein a Device 110 is able to be a CPE (a terminal), User Equipment (UE), an Access Terminal (AT), a subscriber unit, a subscriber station, a mobile station, a remote station, a remote terminal, a mobile device, a user terminal, a wireless communication device, a user agent, a user apparatus, a cellular phone, a cordless phone, a handheld device having a wireless communication function, a computing device, another processing device connected to a wireless modem, a vehicle-mounted device, a wearable device, a terminal in a 5G network, a terminal in a future evolved mobile network, or the like. Devices 110 are able to be managed by a Management Server 120. The Management Server 120 is able to be implemented by using an independent server or a server cluster including a plurality of servers. As described in embodiments herein, an Management Server 120 is able to be an Auto-Configuration Server (ACS).

A Management Server 120 is able to communicate with a Device 110 using a predetermined protocol. In at least one embodiment, the communication between a Device 110 and a Management Server 120 uses an application layer protocol for remote management of end user devices, such as CPEs. In at least one embodiment, Management Server 120 communicates with a Device 110 using a TR-069 protocol.

TR-069 is a protocol, also referred to as a CWMP protocol, is used for remote management and provisioning of CPEs connected to an Internet protocol network. TR069 defines a network management system structure, including a “management model”, an “interaction interface”, and “management parameters.” This is not limited in the embodiments described herein. The Management Server 120 is able to provide one or more of support functions for auto-configuration, software or firmware image management, software module management, status and performance managements, diagnostics, handover, or control of management functions of Device 110s.

In at least one embodiment described herein, a Device 110, such as a CPE, is sometimes described as communicating with a Management Server 120, such as an ACS, using the TR-069 protocol. However, those skilled in the art understand that the implementation of the Device 110 as a CPE, AT, mobile phone, a handheld device having a wireless communication function, a computing device, a subscriber unit, remote terminal, or the like, the implementation of the Management Server 120 as an ACS, or the implementation of communication using the TR-069 protocol are not meant to be limiting, and understand that other devices, servers, or protocols are able to be used without departing from the scope of embodiments described herein. Other protocols are sometimes used to define how a Device 110 in a network is to be managed remotely based on agents and controllers. For example, with TR-069, an ACS is able to manage multiple CPEs. To communicate with CPE, the ACS establishes an HTTP session based on one-by-one requests and responses. However, with other protocols, such as the TR-369 protocol, multiple controllers with different permission settings are able to be subscribed to an agent.

In at least one embodiment, communication is based on an object model in which remote procedure calls (RPC's) are invoked for bidirectional communication between the Device 110 and the Management Server 120. In at least one embodiment, a session or transaction session is based on a sequence of transactions between the Device 110 and the Management Server 120. A session is capable of spanning multiple TCP connections. A transaction is able to include message exchange between the Device 110 and the Management Server 120 involving a Diagnostic Request 130 from the Management Server 120 to the Device 110 followed by a response from the Device 110 to the Management Server.

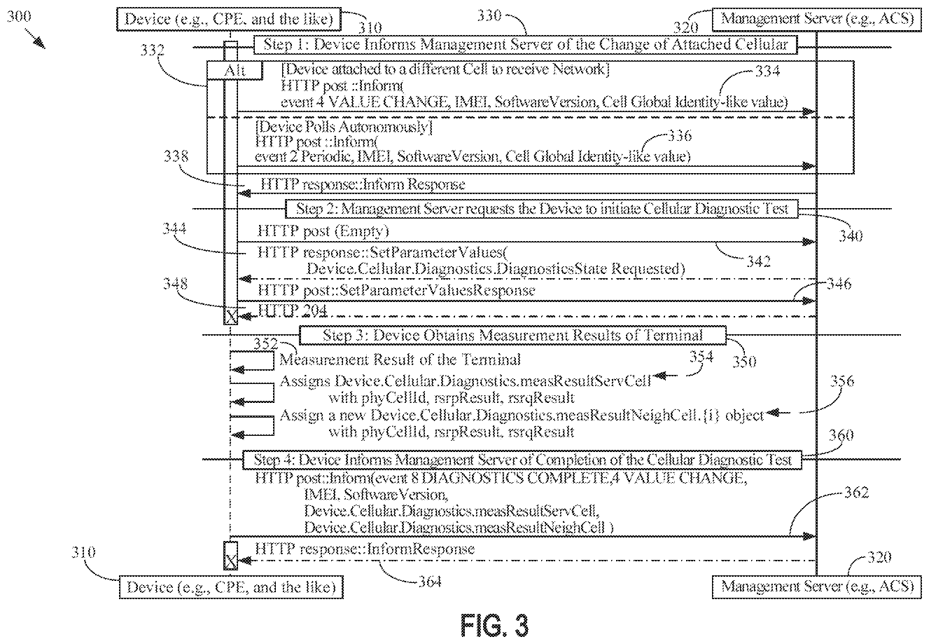

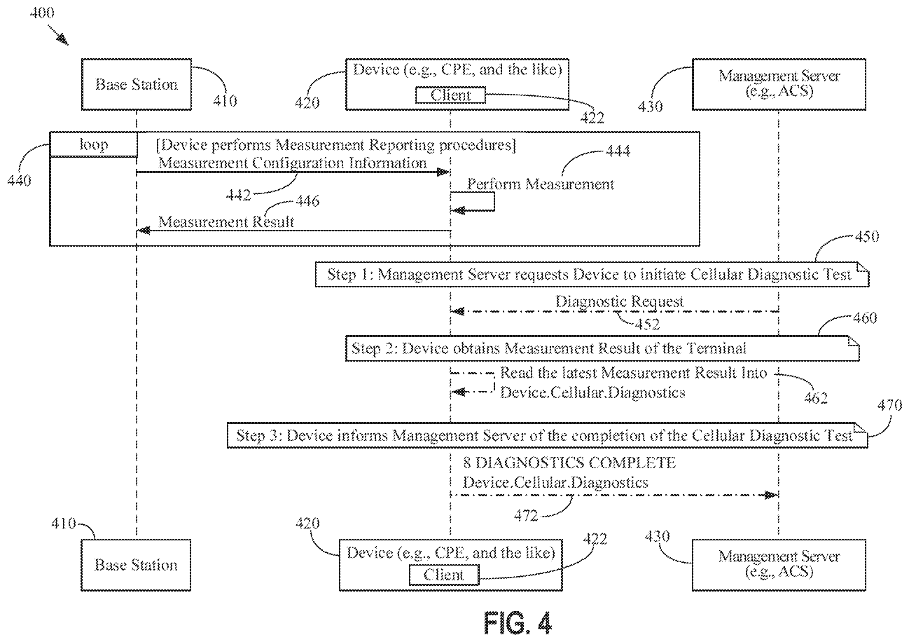

In response to the Diagnostic Request 130, the Client 112 of the Device 110, e.g., CWMP Client, communicates and reads the most recent Measurement Results 116 from a Quality Measurement Procedure 114. The Quality Measurement Procedure 114 is a background process in the Device 110 and is not limited to software or hardware. According to at least one embodiment, the Quality Measurement Procedure 114 is implemented in hardware, such as a System on Chipset and is embedded into the Device 110. Thus, the Device 110 is able to access Measurement Results 116 of the Terminal (FIGS. 3 and 4) from a background daemon process of the Quality Measurement Procedure 114 via a cellular interface, between the Management Server 120 and the Device 110. Particularly, the Quality Measurement Procedure 114 is able to be accessed by the Client 112 of the Device in response to the Diagnostic Request 130 received from the Management Server 120.

In at least one embodiment, messages are able to be bidirectional SOAP- and/or HTTP-based messages. However, those skilled in the art recognize the embodiments described herein are not limited to the described object model for communication between the Device 110 and the Management Server 120, or to the use of SOAP-based or HTTP-based messages.

In FIG. 1, a Management Server 120, such as an ACS, manages the Device 110 and the interface through which the Device 110 is connected to the Management Server 120. For example, an ACS is able to manage a cellular interface for communication between the ACS and the CPE. A Diagnostic Request 130 is able to be sent from the Management Server 120 to the Device 110 with or without a handover taking place at the Device 110.

The Quality Measurement Procedure 114 is able to serve Measurement Results 116 on a regular basis or based on the Client 112 of the Device 110 obtaining the latest Measurement Results 116 based on receipt of the Diagnostic Request 130. In response, the Client 112 of the Device 110 measures a quality for a Serving Cell providing a current service and a quality for Neighbor Cells, and then reports the Measurement Results 116 to the Management Server 120 after configuring the Measurement Results 116. The Client 112 of the Device 110 provides a Cellular Diagnostics Object 140 to the Management Server 120 to report defined cellular diagnostic object 140 carrying Measurement Results 116 obtained from the Quality Measurement Procedure 114. The Cellular Diagnostics Object 140 used to carry the Measurement Results 116 includes parameters of Cellular Diagnostic Data Model that are provided to the Management Server 120 for diagnosing the Device 110 or the at least one base station attached to by the Device 110. Thus, the Management Server 120 is able to test whether the cellular interface is working as expected as per any particular business definitions or conditions.

The Measurement Results 116 includes one or more of a) measurement identity, b) measured serving cell's quality value, c) measured neighbor cell's information, d) neighbor cell identity, or e) measured neighbor cell's information. A person skilled in the art understands that these examples are not meant to be limiting and that other parameters are possible. Measurement Results 116 specified by 3GPP are thus able to be transferred under a predetermined protocol, such as the TR-069 protocol. The Cellular Diagnostic Data Model is a structured representation of the objects, parameters, and their syntax that can be used to “model” a particular use case, such as TR-069 or the like.

For example, the Cellular Diagnostic Data Model is able to be configured in a manner that is similar to the TR-181 data model. TR-181 defines the TR-069 data model. The data model applies to TR-069 enabled Device 110s. For example, a parameter includes a name-value pair. The name identifies the particular parameter and has a hierarchical structure similar to files in a directory, the different levels being separated by a “.” (dot). The value of a parameter may be one of several defined data types. Other data types are able to be used, and a person having ordinary skill in the art is able to recognize that the Cellular Diagnostic Data Model is able to be configured as implementation cases arise. Thus, the Management Server 120 is able to monitor and/or diagnose the radio connection quality for the Device 110.

In at least one embodiment, the Management Server 120 analyzes the Measurement Results 116 provided by the Device 110 according to the Cellular Diagnostics Data Model and sends the Device 110 a command to perform an action according to a determination that is based on analysis of the parameters of the Cellular Diagnostic Data Model. For example, the determination is able to be based on a change of cell ID, and/or a change or degradation in the values of RSRP or RSRQ, compared to the values from latest Measurement Results 116. The determination is also able to be formed based on the parameters of the Cellular Diagnostic Data Model outside of the Management Server 120. The Management Server 120 is able to send a command to the Device 110 with a given determination.

FIG. 2 illustrates a Cellular Diagnostics Data Model 200 defining parameters for the measurement results according to at least one embodiment.

In FIG. 2, the Cellular Diagnostics Data Model 200 defines a structure that include as a base the Device.Cellular.Diagnostics 210 for parameter definitions. A Device obtains measurement results that are then configured into parameters of a Cellular Diagnostic Data Model 200. The Cellular Diagnostics Data Model 200 for the cellular diagnostic measurement report according to at least one embodiment is configured similar to the TR-181 Device: 2 Data Model, Amendment 12, and is able to keep consistency across the whole TR-181 design policy. The parameters definitions in the Cellular Diagnostics Data Model 200 is also able to use the measurement results as specified in 3GPP TS 36.331.

The parameters in the Cellular Diagnostics Data Model 200 include name and value pairs. Thus, the parameters associated with a cellular diagnostic test are defined as an extension to the Device. Cellular interface object defined in TR-181 Device: 2 Data Model. The name and value pairs of the parameters for the cellular diagnostic measurement report according to at least one embodiment provide a name that identifies the parameter and the value is provided according to defined data types, e.g., integer or string.

The Device.Cellular.Diagnostic 210 includes:
Device.Cellular.Diagnostics.measResultServCell 220,
Device.Cellular.Diagnostics.measResultNeighCell.1 240, and
Device.Cellular.Diagnostics.measResultNeighCell.2 260.

Those skilled in the art recognize that additional measurements results for the Device.Cellular.Diagnostics 210, including cellular diagnostics for other Neighbor Cells, are able to be provided using the same format. Further, the Device.Cellular.Diagnostics 210 is not meant to be limited to particular number formats.

Measurement results of the cellular diagnostics of a serving cell, Device.Cellular.Diagnostics.measResultServCell 220 includes a name phyCellID 222 that is defined as an integer 223, an rsrpResult 224 that is defined as an integer 225, and an rsrqResult 226 that is defined as an integer 227. However, as mentioned other measurements and number formats are able to be used.

Measurement results of the cellular diagnostics of a first Neighbor Cell, (Device.Cellular.Diagnostics.measResultNeighCell.1 240 includes a name phyCellID 242 that is defined as an integer 243, an rsrpResult 244 that is defined as an integer 245, and an rsrqResult 246 that is defined as an integer 247. However, as mentioned other measurements and number formats are able to be used.

Measurement results of the cellular diagnostics of a second Neighbor Cell, Device.Cellular.Diagnostics.measResultNeighCell.2 260, includes a name phyCellID 262 that is defined as an integer 263, a name rsrpResult 264 that is defined as an integer 265, and an rsrqResult 266 that is defined as an integer 267. However, as mentioned other measurements and number formats are able to be used. Further, as mentioned above, additional measurements results are able to be provided as the Device.Cellular.Diagnostics 210.

TR-181 describes a data model but lacks specific parameters for the Cellular Diagnostic Model described in embodiments herein. However, the information, including the terms of a Serving Cell and the Neighbor Cells, along with the physical Cell ID and the connection qualities, are not specified in TR-181. TR-181 specifies a cellular interface table with object models for a cellular modem with a radio and a Universal Subscriber Identity Module (USIM). Device.Cellular.Interface.{i}.USIM specifies parameters for the interface to the USIM. TR-181 also specifies diagnostics information for a CPE with an Asymmetric Digital Subscriber Line 2 (ADSL2) or ADSL2+ modem Wide Area Network (WAN) interface, but is also used for ADSL. A Home Phoneline Networking Alliance (HPNA) object includes the interface and diagnostics objects. The HPNA (also known as HomePNA) standard defines peer-to-peer communication for home networking over existing coax cables and telephone wiring within the home. HPNA diagnostic objects are used to sample performance monitoring results from nodes in the HPNA network. Thus, TR-181 does not specify information for a Cellular Diagnostics Data Model as described in embodiment herein.

The parameters for the Cellular Diagnostic Data Model 200 are not defined in a TR-069 context, therefore the additional parameters described above are defined for the Cellular Diagnostic Data Model 200. The benefits in following the format for parameters similar to the format of parameters as specified in TR-181 is consistency in formal and easily grasped understanding of the parameters. The Broadband Forum defined active monitoring and diagnostics guidelines, where tests are used to check and measure performance of a given link in real time using the TR-069 Endpoint as a probe. However, Vendors had to directly push customized parameters using the TR-069 communication protocol, rather than directly delivering parameters to the ACS using an existing communication process, e.g., TR-069 communication protocol.

Further, proprietary methods do not leverage TR-069 to increase traffic as new features are used, and thus rely on additional redesign of existing methods. Vendors are able to obtain the same data through antennas of the CPE, but the handling of the data using proprietary methods to communicate that data does not leverage TR-069 communication using the structure of the TR-181 data model. Even though vendors are able to obtain the same data through antennas of the CPE, the Subscriber Identity Module (SIM) card is not related to CWMP Cellular Diagnostics Test Method according to at least one embodiment. Thus, according to at least one embodiment, the Cellular Diagnostics and the Cellular Diagnostic Data Model 200 avoids these disadvantages.

The Cellular Diagnostic Data Model 200, according to at least one embodiment, fulfils the requirements of TR-069. The Cellular Diagnostic Data Model 200 is able to be viewed as an extension to the TR-181 model that enables the cellular information to be obtained by the Client of the Device rather than directly pushing the same cellular information as customized parameters towards the Management Server. Other sequences or other steps are not relied upon.

FIG. 3 illustrates the cellular diagnostics mechanism 300 triggered by change of attachment of a device to a base station according to at least one embodiment.

In FIG. 3, the details for the communication between the Device (e.g., CPE), and Management Server (e.g., ACS) are based on a cell environment as shown below:

| Frequency | Cells |
|---|---|
| f1 | Cell 1 |
| f2 | — |
| f3 | Cell 2, Cell 3 |
| f4 | |

A Device 310 is served by Cell 1. The Device 310 provides the network measurements for Cell 1, while also measuring Cell 2 and Cell 3 as secondary cells to be included in measured results of a Neighbor Cell.

In Step 1 330, the Device 310 informs the Management Server 320 of the change of attachment of the Device from Cell 1. The Device 310 informs 332 the Management Server 320. The Device 310 sends Management Server 320 a message such as an HTTP post::Inform message 334 with values event 4 VALUE CHANGE, IMEI, Software Version, and Cell Global Identity-like value. The 4 VALUE CHANGE event occurs in response to a parameter set for notification that is changed by any mechanism other than the Management Server 320. The International Mobile Station Equipment Identity (IMEI) number uniquely identifies the Device 310, Software Version identifies the version of the firmware of the Device 310, and the Cell Global Identity-like value is a globally unique identifier for a Base Station.

The Device 310 is also able to poll autonomously using HTTP post::Inform event 2 Periodic message 336. The event 2 Periodic message 336 is sent whenever the Periodic Inform Interval of the Device 310 expires. This is used to ensure that the Device 310 contacts the Management Server 320 on a regular, planned interval. The event 2 Periodic message 336 includes IMEI of the Device 310, SoftwareVersion of the Device 310, and Cell Global Identity-like value is a globally unique identifier for a base station.

Management Server 320 responds with an HTTP response::InformResponse message 338. HTTP response::InformResponse message 338 from the Remote Management Server 320 is used to acknowledge the latest cell inform from Device 332.

In Step 2 340, the Management Server 320 requests the Device 310 to initiate a Cellular Diagnostic Test. The Device 310 sends the Management Server 320 an HTTP post (Empty) message 342. The HTTP post (Empty) message 342 for the Device 310 indicates that the Client of the Device 310 is ready to initiate the Cellular Diagnostic Test.

The Management Server 320 sends the Device 310 a HTTP response::SetParameterValues (Device.Celllular.Diagnostics.DiagnosticsState Requested) message 344 indicating the Management Server 320 wants the Device 310 to initiate Cellular Diagnostics.

The Device 310 responds with HTTP post::SetParameter ValuesResponse message 346. The HTTP post::SetParameterValuesResponse message 346 is used by the Device 310 to acknowledge that the Device 310 is initiating the Cellular Diagnostics.

The Management Server 320 sends the Device 310 an empty message, i.e., HTTP 204 message 348, in response to the Device 310 indicating acknowledgement of the request to initiate Cellular Diagnostics.

In Step 3 350, the Device 310 obtains measurement results from the Quality Measurement Procedure. The Device 310 begins obtaining the measurement results of the terminal 352. The Device 310 assigns Device.Cellular.Diagnostics.measResultServCell 354 for the Serving Cell (e.g., Cell 1) with the result value of physical cell identity (phyCellID), Reference Signal Received Power results (rsrpResult), and Reference Signal Received Quality (rsrqResult) of the Serving Cell from the latest measurement result of the terminal 352.

The Device 310 assigns the measurement result from the latest measurement result of the terminal for Neighbor Cell {i} into Device.Cellular.Diagnostics.measResultNeighCell.{i} message 356 referring to the physical cell identity (phyCellID), Reference Signal Received Power results (rsrpResult), and Reference Signal Received Quality (rsrqResult) of the ith Neighbor Cell. Measurement results for additional or other Neighbor Cells are obtained and assigned in a similar manner.

In Step 4 360, the Device 310 informs the Management Server 320 of the completion of the Cellular Diagnostics. The Device 310 sends the Management Server 320 the measurement result values obtain during the Cellular Diagnostics using HTTP post::Inform message 362 with (event 8 DIAGNOSTICS COMPLETE, 4 VALUE CHANGE, IMEI, Software Version, Device.Cellular.Diagnostics.measResultServCell, Device.Cellular.Diagnostics.measResultNeighCell.{i}).

The Management Server 320 sends the Device 310 a message as an acknowledgement, i.e., HTTP response::InformResponse message 364, in response to the Device 310 sending the Management Server 320 the measurement values for the Serving Cell and the Neighbor Cells obtained from the Cellular Diagnostics.

FIG. 4 illustrates a Device executing cellular diagnostics to transfer 3GPP measurement reports into a TR-069 communication model for consumption by a Management Server according to at least one embodiment.

In FIG. 4, a Device 420 performs Measurement Reporting procedures 440 with a Base Station 410. The Base Station 410 provides measurement configuration 442 to a Device 420, such as a CPE, and the like. The Device 420 performs a measurement 444 for the consequent report 446 to a network in a 3GPP LTE system. The Device 420 then reports the measurement result 446 included in a measurement report message to the Base Station 410.

In Step 1 450, the Management Server 430, such as an ACS, via CWMP SetParameterValues sets the DiagnosticsState to Requested as a Diagnostic Request message 452 is sent to the Device 420 for the Device 420 to initiate cellular diagnostics.

In Step 2 460, the Device 420 obtains the latest measurement results 446 that the current Device most recently reported to Base Station 410. The Device 420 reads the latest measurement results from the cellular diagnostics into Device.Cellular.Diagnostics 462.

In Step 3 470, the Device 420 informs the Management Server 430 of the completion of the cellular diagnostics. The Device 420 sends the Management Server 430 a CWMP Event “8 DIAGNOSTICS COMPLETE” in a CWMP Inform 472 with the measurement results in Device.Cellular.Diagnostics.

According to at least one embodiment, a Client 422 of the Device 420 is able to report the location and assists the carrier in locating the Device 420 directly using the information identifying the Base Station 410, especially in response to retrieval from ACS of measurement results of the Serving Cell and the Neighbor Cells. The location of the cell is able to be represented without using traditional means, such as Global Navigation Satellite System (GNSS), which is based on satellites that provide positioning, navigation, and timing (PNT) services on a global or regional basis. GPS (or Global Positioning System) is one such type of GNSS. Measurement results 446 reported to Base Station 410 are thus able to be used to determine the location of a reporting Device 420.

Also, once a Device 420 moves within a network, the Serving Cell is able to change. The Device 420 provides the measurements results to the Management Server 430 periodically so that the Management Server 430 is able to check whether the Device 420 has moved within the network (and is now closer to a Neighbor Cell). The Management Server 430 is able to initiate the cellular diagnostics to obtain the measurements using a Diagnostic Request message. For example, measurement results shared with both reporting to Base Station and configuring TR-069 Diagnostics data model are obtained from the chipsets that implement the features via the Radio Resource Control (RRC) connections.

The measurement results are shared to the cellular diagnostics, including the cell IDs, RSRP results, and RSRQ results about the Serving Cell and Neighbor Cells. In at least one embodiment, the measurement results are able to be extracted and reloaded into a Cellular Diagnostic Data Model, which, in one embodiment, is able to be configured in a manner that is similar to the TR-181 data model and provided to the Management Server 430 using the TR-069 communication protocol. In case of TR-069, the extracted data in the format of the TR-069 communication protocol is shared with an ACS. The Device 420 informs the obtained measurement results using a predetermined message, such as an HTTP post::Inform message. The Cellular Diagnostic Data Model describes how the 3GPP defined information is made visible to the Management Server 430 without the use of other server-side components, especially without any new provisions being made to the 3GPP context. A benefit from the Cellular Diagnostic is that the measurement results are able to be used to help record, calculate and monitor the location of the Device 420.

The Serving Cell and Neighbor Cells visible from a Device 420 represent an area where the Device 420 is located. For example, where there are two Devices (e.g., two CPEs), Device Dₐ and Device D_{b}, the cell environment is as follows:

| Frequency | Cells |
|---|---|
| f1 | c1 |
| f2 | — |
| f3 | c2, c3 |
| f4 | c4 |

wherein Device Dₐ is served by cell c1 as a Serving Cell, and Device Dₐ sees the radios from cell c2 and cell c3. The location of Device Dₐ is represented as

$${ε}_{a} = \{ c 1 , c 2 , c 3 \} .$$

Device D_{b} is served by cell c4 as a Serving Cell and, Device D_{b} sees the radio signals from cell c2 and cell c3, wherein the location of Device D_{b} is represented as

$${ε}_{b} = \{ c 2 , c 3 , c 4 \} .$$

Let J (Dₐ, D_{b}) be the Location Similarity between Device Dₐ and Device D_{b}, wherein the Location Similarity is measured by a Jaccard Similarity Index:

$$J ( {D}_{a} , {D}_{b} ) = \frac{{ε}_{a} ⋂ {ε}_{b}}{{ε}_{a} ⋃ {ε}_{b}} .$$

$$Let$$

$${ε}_{a} = \{ {s}_{a} \} ⋃ {𝒩}_{a} ,$$

where sₐ denotes the Serving Cell c1 that serves network for Device Dₐ, and [symbol] denotes the set of Neighbor Cells (c2, c3) visible for Device Dₐ.

### Let

$${ε}_{b} = \{ {s}_{b} \} ⋃ {𝒩}_{b} ,$$

where s_{b} denotes the Serving Cell c4 that serves network for Device D_{b}, and N b denotes the set of Neighbor Cells (c2, c3) visible for Device D_{b}.

The Location Similarity between Device Dₐ and Device D_{b} is represented as the Jacard Similarity Index:

$$J ( {D}_{a} , {D}_{b} ) = \frac{( \{ {s}_{a} \} ⋃ {𝒩}_{a} ) ∩ ( \{ {s}_{b} \} ⋃ {𝒩}_{b} )}{\{ {s}_{a} , {s}_{b} \} ⋃ {𝒩}_{a} ⋃ {𝒩}_{b}} .$$

In the cell environment, one device, Device Dₐ, is able to see three cells, c1, c2, c3, and another device, Device D_{b}, is able to see three cells, c2, c3, c4. Thus, Device Dₐ and Device D_{b} are able to be described using the above Jacard Similarity Index, which ranges from 0 to 1, where the closer the Jacard Similarity Index is to 1, the more similar the two sets of data are (or the closer Device Dₐ and Device D_{b} are to each other), and where the closer the Jacard Similarity Index is to 0, the less similar the two sets of data are (or the farther apart Device Dₐ and Device D_{b} are to each other).

Currently, a Management Server 430, such as an ACS, is not able to obtain access to the quality measurement results. TR-069 and TR-181 are technical specifications of the Broadband Forum (formerly The DSL Forum), which is different from 3GPP. The Broadband Forum has a long history with copper-based access, starting with ADSL and then VDSL. The Broadband Forum released the CPE WAN Management Protocol (CWMP), which is more commonly known as TR-069. The TR-069 protocol standardizes the wide-area network (WAN) management of CWMP devices by providing a framework and common language to remotely provision and manage CWMP devices, which are usually in a home network, regardless of device type or manufacturer. Thus, it was not needed for the standards of the Broadband Forum to utilize any quality measurement results that could be obtained by implementing Quality Measurement Procedure in line with relevant standards of 3GPP, and thus originally there was no compatibility between the standards of the Broadband Forum and the 3GPP, and an ACS and CPE are not able to use the quality measurement results through implementation of the technical specifications of the 3GPP.

However, according to at least one embodiment, an application layer protocol, e.g., the TR-069 communication protocol, and the Cellular Diagnostics Data Model, which specifies a configuration similar to TR-181, is used to enable a Management Server 430, such as ACS, to obtain quality measurement results from the Client 422 of the Device 420, such as a CPE.

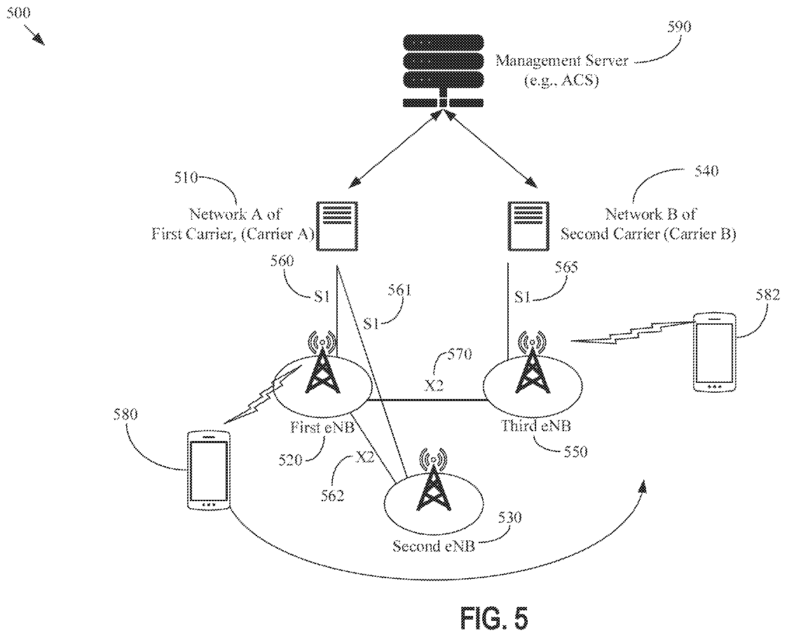

FIG. 5 shows handover handling between two carriers 500 according to at least one embodiment.

In FIG. 5, a First Carrier Network, Network A 510, is shown connected to a First eNB 520 and a Second eNB 530. A Second Carrier Network, Network B 540, is shown connected to the Second eNB 530 and a Third eNB 550. Network A 510 is able to communicate with the First eNB 520 and the Second eNB 530 using a First S1 interface 560 and a Second S1 interface 561. First eNB 520 is able to communicate with Second eNB 530 using an X2 interface 562. Network B 540 is able to communicate with the Second eNB 530 using a Third S1 interface 564. The First Carrier Network, Network A 510, and the Second Carrier Network, Network B 540, sometimes agree to share an interface, X2 interface 570.

However, a First Device 580 is expected to be connected using one Carrier Network. However, in FIG. 5, the First Device 580 is able to connect to different eNBs, e.g., First eNB 520 and Third eNB 550, which are able to belong to First Carrier Network, Network A 510, and Second Carrier Network, Network B 540, respectively. In such circumstances, measurement results indicate that a handover would be beneficial between First eNB 520 of First Carrier Network, Network A 510, to Third eNB 550 of Second Carrier Network, Network B 540. To handle such handovers, First Carrier Network, Network A 510, and Second Carrier Network, Network B 540, have to use the X2 interface 570 for communication.

Without an interface, e.g., X2 interface 570, between first Carrier Network, Network A 510, and second Carrier Network, Network B 540, handover is able to occur within the network of a particular carrier (between First eNB 520 and Second eNB 530), but not between first Carrier Network, Network A 510, and second Carrier Network, Network B 540 (between First eNB 520 and Third eNB 550). For example, in response to the First Device 580 being connected to a First eNB 520 of Network A 510, Network A 510 is able to send a request or command that prompts the First Device 580 to obtain measurement results from the First Device 580 for handover between First eNB 520 and Second eNB 530. In response to the First Device 580 being connected to a Second eNB 530 of Network B 540, Network B 540 is able to obtain measurement results from the First Device 580 for handover between Second eNB 530 and Third eNB 550.

Network A 510 is thus able to obtain measurements from the First Device 580 to determine whether there is a problem with the First Device 580 or whether there is a problem with a signal from a base station, e.g., First eNB 520, which is able to be a base station that Network B 540 is not able to control. Thus, in response to First Carrier Network, Network A 510, not implementing a shared interface (X2 interface 570) with Second Carrier Network, Network B 540, handover is able to be performed between the First eNB 520 and the Second eNB 530, but not between, for example, the First eNB 520 and the Third eNB 550.

Also as shown in FIG. 5, according to at least one embodiment, a First Device 580, which is connected to first Carrier Network, Network A 510, is able to obtain measurements about First eNB 520 and Second eNB 530 of Network A 510, and a Second Device 582, which is connected to second Carrier Network, Network B 540, is able to obtain measurements about Second eNB 530 and Third eNB 550 of Network B 540. In some circumstances, the First Device 580 is also able to obtain measurements about Third eNB 550 of Network B 540. In these circumstances, a Management Server 590 is able to monitor measurement results of Network A 510 and Network B 540 without requests being made to Network B 540. Thus, according to at least one embodiment, there is no longer a constraint due to a base station belonging to a different carrier. Measurement results obtain from Cellular Diagnostics are able to be obtained by one or more of the First Device 580 and the Second Device 582, and delivered to the Management Server 590, wherein the Management Server 590 is then able to troubleshoot the issue being experienced by one or more of the First Device 580 or the Second Device 582, to obtain information that could point out the issue may be with the Device or the Base Station. The Management Server 590 is also able to prompt the handover of one of the First Device 580 or the Second Device 582 to a base station of a same carrier or of a different carrier.

The manner that First Device 580 connects to a carrier does not matter. In response to the First Device 580 and the Second Device 582 having an Internet connection, the First Device 580 and the Second Device 582 is able to communicate with the Management Server 590, for example, via HTTP. The First Device 580 and the Second Device 582 are able to therefore provide the Management Server 590 measurement results obtained through Cellular Diagnostics. The Management Server 590 is able to initiate the Cellular Diagnostics by sending a command to one or more of the First Device 580 or the Second Device 582 to scan the ambient environment.

Not only is the Management Server 590 able to use measurement results associated with Network A 510 and Network B 540 to troubleshoot connectivity issues being experienced by, for example, the First Device 580 connected to a Network A 510, but the Management Server 590 is also able to compare measurements associated with Network A 510 and Network B 540 and request the First Device 580 to connect to a Neighbor Cell, e.g., Third eNB 550, that is determined to be able to provide better communication quality even in response to the Neighbor Cell, e.g., Third eNB 550, belonging to a different network, Network B 540, operated by a different carrier.

For example, Management Server 590 sends a request to the First Device 580 to prompt the First Device 580 to perform Cellular Diagnostics to obtain measurement results. The request is able to be provided to support control of a handover. The First Device 580 is able to obtain measurement results from a Serving Cell, e.g., First eNB 520, and a plurality of neighbor cells, e.g., Second eNB 530 and Third eNB 550. In response to the Third eNB 550 of Network B 540 operated by the Second Carrier being determined to provide a stronger signal than the current base station, e.g., First eNB 520, of Network A 510 that is connected to the First Device 580, the Management Server 590 is able to provide mobility management between the First eNB 520 of Network A 510 operated by the first carrier and Third eNB 550 of Network B 540 operated by the Second Carrier. The Management Server 590 thus prompts the First Device 580 to disconnect from the First eNB 520 of Network A 510 and to attach to the Third eNB 550 of Network B 540.

Previously, in response to the First Device 580 connected to First eNB 520 in Network A 510 moving to a location of the Third eNB 550 in Network B 540, a handover to the Third eNB 550 in Network B 540 is able to take place in response to the X2 interface 570 being provided by cooperation between the First Carrier of Network A 510 and the Second Carrier of Network B 540. However, according to at least one embodiment, the Management Server 590 is able to communicate with the First Device 580 to execute the handover of the First Device 580 from First eNB 520 in Network A 510 to the Third eNB 550 in Network B 540 based on periodic measurements regarding Network A 510 and Network B 540 obtained by the First Device 580 using the measurement results of Cellular Diagnostics performed by the First Device 580.

In response to the First Device 580 being closer to the Third eNB 550 in Network B 540, but the Third eNB 550 in Network B 540 is out of service or the quality has deteriorated below a predetermined level, the Management Server 590 is able to troubleshoot the issue based on periodic measurements obtained from the measurement results obtained from the Cellular Diagnostics performed by the First Device 580, and identify that the issue is at the Third eNB 550. This would otherwise not be possible for the First Carrier of Network A due to the fact that the First Carrier of Network B does not own the Third eNB 550. In response to understanding that the issue is with the base station of another carrier, the Management Server 590 is able to send a command for the First Device 580 to deal with the situation, and for example prompt the First Device 580 to connect back with the First eNB 520 in Network A 510 or to connect to Second eNB 530 in Network A 510.

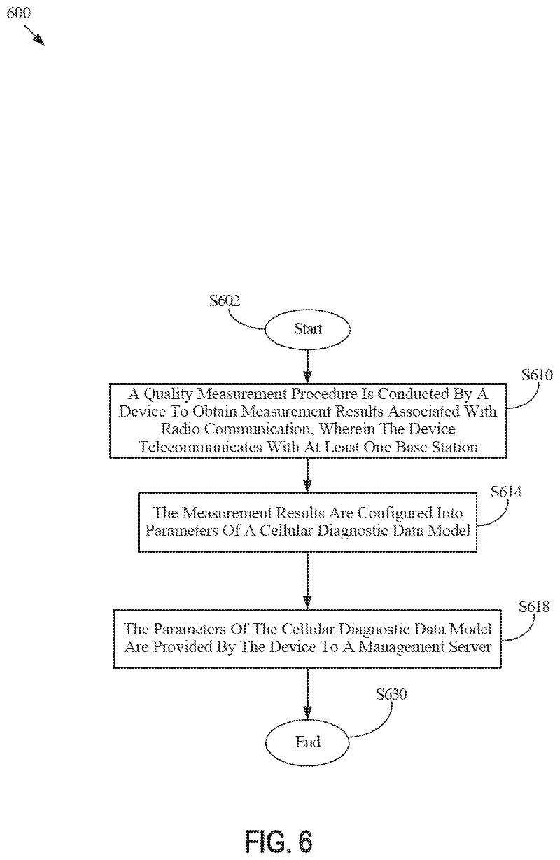

FIG. 6 is a flowchart 600 of a method for performing cellular diagnostics according to at least one embodiment.

In FIG. 6, the method begins S602 along with a daemon process, the quality measurement procedure, that is continuously performing measurement report to base stations.

A Device conducts a Quality Measurement Procedure to obtain measurement results associated with radio communication, wherein the device telecommunicates with at least one base station S610. Referring to FIG. 1, a Device 110, such as Customer-Premises Equipment (CPE), mobile phone, and the like, communicates with a Management Server 120, such as an Auto-Configuration Server (ACS). The Device 110 is able to access Measurement Results 116 of the Terminal (FIGS. 3 and 4) from a background daemon process of the Quality Measurement Procedure 114 via a cellular interface, between the Management Server 120 and the Device 110. Particularly, the Quality Measurement Procedure 114 is able to be accessed by the Client 112 of the Device in response to the Diagnostic Request 130 received from the Management Server 120. Referring to FIG. 5, Management Server 590 sends a request to the First Device 580 to prompt the First Device 580 to perform Cellular Diagnostics to obtain measurement results. The request is able to be provided to support control of a handover. The First Device 580 is able to obtain measurement results from a Serving Cell, e.g., First eNB 520, and a plurality of neighbor cells, e.g., Second eNB 530 and Third eNB 550. In response to the Third eNB 550 of Network B 540 operated by the Second Carrier being determined to provide a stronger signal than the current base station, e.g., First e520, of Network A 510 that is connected to the First Device 580, the Management Server 590 is able to provide mobility management between the First eNB 520 of Network A 510 operated by the first carrier and Third eNB 550 of Network B 540 operated by the Second Carrier. The Management Server 590 thus prompts the First Device 580 to disconnect from the First eNB 520 of Network A 510 and to attach to the Third eNB 550 of Network B 540. Referring to FIG. 5, Management Server 590 sends a request to the First Device 580 to prompt the First Device 580 to perform Cellular Diagnostics to obtain measurement results.

The measurement results are configured into parameters of a Cellular Diagnostic Data Model S614. Referring to FIG. 2, a Device obtains measurement results that are then configured into parameters of a Cellular Diagnostic Data Model 200. The Cellular Diagnostics Data Model 200 for the cellular diagnostic measurement report according to at least one embodiment is configured similar to the TR-181 Device: 2 Data Model, Amendment 12, and is able to be keep consistency across the whole TR-181 design policy. The parameters definitions in the cellular diagnostics model is similar to the configuration of measurement results as specified in 3GPP TS 36.331. The parameters in the Cellular Diagnostics Data Model 200 include name and value pairs. Thus, the parameters associated with a cellular diagnostic test are defined as an extension to the Device.Cellular interface object defined in TR-181 Device: 2 Data Model. The name and value pairs of the parameters for the cellular diagnostic measurement report according to at least one embodiment provide a name that identifies the parameter and the value is provided according to defined data types, e.g., integer or string. Through a discovery process, the management server learns what parameters a particular device supports. For example, the TR-069 discovery process is able to be used by the ACS learns to learn what parameters a particular CPE supports. The Device.Cellular.Diagnostic 210 includes: Device.Cellular.Diagnostics.measResultServCell 220, Device.Cellular.Diagnostics.measResultNeighCell.1 240, and Device.Cellular.Diagnostics.measResultNeighCell.1 260. Those skilled in the art recognize that additional measurements results for the Device.Cellular.Diagnostics 210, including cellular diagnostics for other Neighbor Cells, are able to be provided using the same format. Further, the Device.Cellular.Diagnostics 210 is not meant to be limited to particular number formats. Measurement results of the cellular diagnostics of a serving cell, Device.Cellular.Diagnostics.measResultServCell 220 includes a name phyCellID 222 that is defined as an integer 223, a name rsrpResult 224 that is defined as an integer 225, and an rsrqResult 226 that is defined as an integer 227. However, as mentioned other number formats are able to be used. Measurement results of the cellular diagnostics of a first Neighbor Cell, (Device.Cellular.Diagnostics.measResultNeighCell.1 240 includes a name phyCellID 242 that is defined as an integer 243, a name rsrpResult 244 that is defined as an integer 245, and an rsrqResult 246 that is defined as an integer 247. Measurement results of the cellular diagnostics of a second Neighbor Cell, Device.Cellular.Diagnostics.measResultNeighCell.2 260, includes a name phyCellID 262 that is defined as an integer 263, a name rsrpResult 264 that is defined as an integer 265, and an rsrqResult 266 that is defined as an integer 267. Referring to FIG. 1, a Device 110, such as Customer-Premises Equipment (CPE), mobile phone, and the like, communicates with a Management Server 120, such as an Auto-Configuration Server (ACS). The Device 110 is able to implement a Client 112, such as a CPE WAN Management Protocol (CWMP) Client. The Client 112 communicates with the Management Server 120 using a specific communication protocol for providing the parameters of a cellular diagnostics data model.

The parameters of the Cellular Diagnostic Data Model are provided by the device to a management server S618. Referring to FIG. 1, the Quality Measurement Procedure 114 is able to serve Measurement Results 116 on a regular basis or based on the Client 112 of the Device 110 obtaining the latest Measurement Results 116 based on receipt of the Diagnostic Request 130. In response to the serving of the Measurement Results 116, the Client 112 of the Device 110 configures the Measurement Results 116 into Cellular Diagnostic Data Model, which is then provided to the Management Server 120 for diagnosing the Device 110 or the at least one base station attached to by the Device 110. The parameters of Cellular Diagnostic Data Model include those indicative of a quality for a Serving Cell providing a current service and a quality for Neighbor Cells. Thus, the Management Server 120 is able to test whether the cellular interface is working as expected as per any particular business definitions or conditions.

The process then terminates S630.

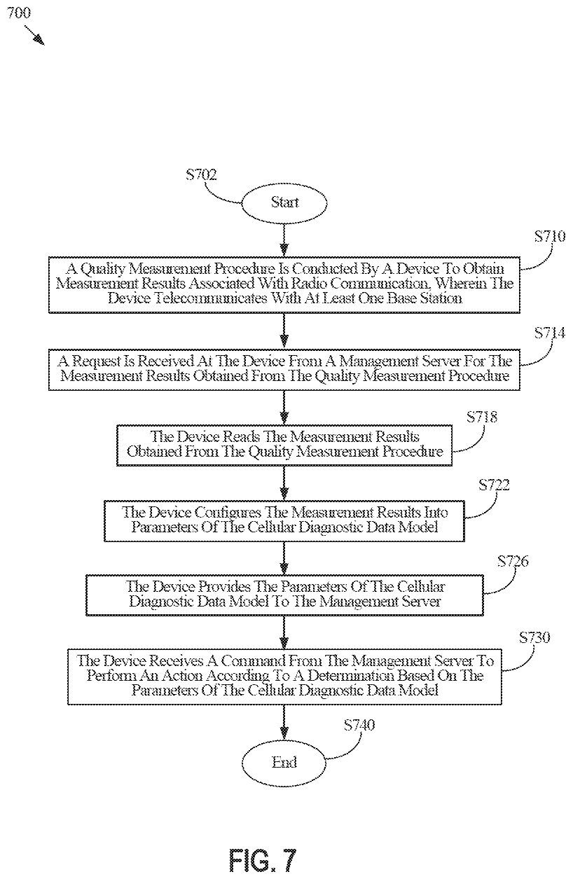

FIG. 7 is a flowchart of a method for a device to respond to requests and/or commands from a management server according to at least one embodiment.

In FIG. 7, the process begins S702 and a quality measurement procedure is conducted by a device to obtain measurement results associated with radio communication, wherein the device telecommunicates with at least one base station S710. Referring to FIG. 1, a Device 110, such as Customer-Premises Equipment (CPE), mobile phone, and the like, communicates with a Management Server 120, such as an Auto-Configuration Server (ACS). The Device 110 is able to access Measurement Results 116 of the Terminal (FIGS. 3 and 4) from a background daemon process of the Quality Measurement Procedure 114 via a cellular interface, between the Management Server 120 and the Device 110.

A request is received at the device from a management server for the measurement results obtained from the quality measurement procedure S714. Referring to FIG. 4, the Management Server 430, such as an ACS, via CWMP SetParameterValues sets the DiagnosticsState to Requested as a Diagnostic Request message 452 is sent to the Device 420 for the Device 420 to initiate cellular diagnostics.

The device reads the measurement results obtained from the quality measurement procedure S718. Referring to FIG. 4, the Device 420 obtains the latest measurement results 446 that the current Device most recently reported to Base Station 410. The Device 420 reads the latest measurement results from the cellular diagnostics into Device.Cellular.Diagnostics 462.

The device configures the measurement results into parameters of the Cellular Diagnostic Data Model S722. Referring to FIG. 4, the measurement results are able to be extracted and reloaded into a Cellular Diagnostic Data Model, which, in one embodiment, is able to be configured in a manner that is similar to the TR-181 data model.

The device provides the parameters of the Cellular Diagnostic Data Model to the management server S726. Referring to FIG. 4, the measurement results are able to be extracted and reloaded into a Cellular Diagnostic Data Model, which, in one embodiment, is able to be configured in a manner that is similar to the TR-181 data model and provided to the Management Server 430 using the TR-069 communication protocol. In case of TR-069, the extracted data in the format of the TR-069 communication protocol is shared with an ACS. The Device 420 informs the obtained measurement results using a predetermined message, such as an HTTP post::Inform message. The Cellular Diagnostic Data Model describes how the 3GPP defined information is made visible to the Management Server 430 without the use of other server-side components, especially without any new provisions being made to the 3GPP context.

The Device receives a command from the management server to perform an action according to a determination based on the parameters of the Cellular Diagnostic Data Model S730. Referring to FIG. 1, the Management Server 120 analyzes the Measurement Results 116 provided by the Device 110 according to the Cellular Diagnostics Data Model and sends the Device 110 a command to perform an action according to a determination that is based on analysis of the parameters of the Cellular Diagnostic Data Model. For example, the determination is able to be based on a change of cell ID, and/or a change or degradation in the values of RSRP or RSRQ, compared to the values from latest Measurement Results 116. The determination is also able to be formed based on the parameters of the Cellular Diagnostic Data Model outside of the Management Server 120. The Management Server 120 is able to send a command to the Device 110 with a given determination.

The process then terminates S740.

At least one embodiment, a method for performing cellular diagnostics includes conducting Input/Output, in a device, with a quality measurement procedure to obtain measurement results associated with radio communication, wherein the device telecommunicates with at least one base station, configuring the measurement results into parameters of a Cellular Diagnostic Data Model; and providing, by the device, the parameters of the Cellular Diagnostic Data Model to a management server.

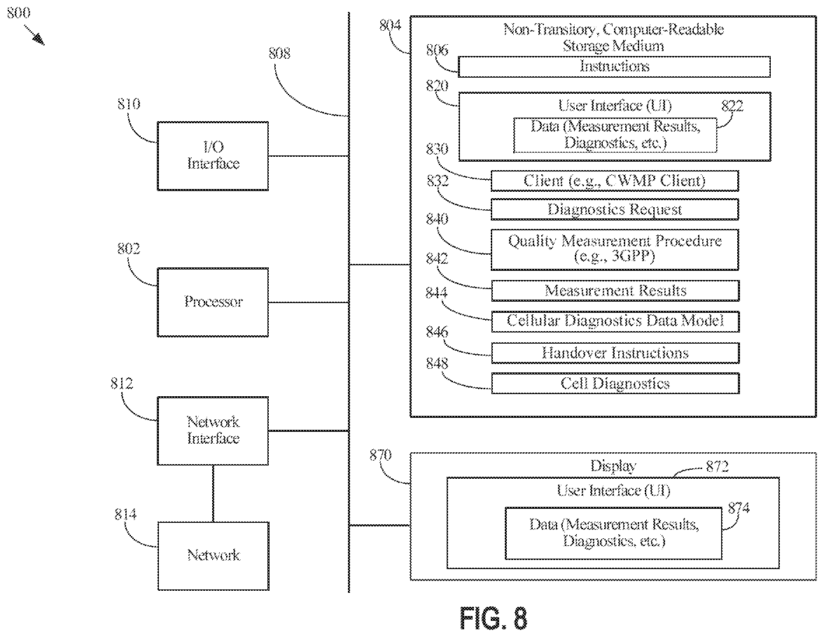

FIG. 8 is a high-level functional block diagram of a processor-based system 800 according to at least one embodiment.

In at least one embodiment, processing circuitry 800 performs cellular diagnostics. Processing circuitry 800 implements a method for performing cellular diagnostics using Processor 802. Processing circuitry 800 also includes a Non-Transitory, Computer-Readable Storage Medium 804 that is used to implement the method for performing cellular diagnostics. Non-Transitory, Computer-Readable Storage Medium 804, amongst other things, is encoded with, i.e., stores, Instructions 806, i.e., computer program code, that are executed by Processor 802 causes Processor 802 to perform operations for performing cellular diagnostics. Execution of Instructions 806 by Processor 802 represents (at least in part) an application which implements at least a portion of the methods described herein in accordance with one or more embodiments (hereinafter, the noted processes and/or methods).

Processor 802 is electrically coupled to Non-Transitory, Computer-Readable Storage Medium 804 via a Bus 808. Processor 802 is electrically coupled to an Input/Output (I/O) Interface 810 by Bus 808. A Network Interface 812 is also electrically connected to Processor 802 via Bus 808. Network Interface 812 is connected to a Network 814, so that Processor 802 and Non-Transitory, Computer-Readable Storage Medium 804 connect to external elements via Network 814. Processor 802 is configured to execute Instructions 806 encoded in Non-Transitory, Computer-Readable Storage Medium 804 to cause processing circuitry 800 to be usable for performing at least a portion of the processes and/or methods. In one or more embodiments, Processor 802 is a Central Processing Unit (CPU), a multi-processor, a distributed processing system, an Application Specific Integrated Circuit (ASIC), and/or a suitable processing unit.

Processing circuitry 800 includes I/O Interface 810. I/O interface 810 is coupled to external circuitry. In one or more embodiments, I/O Interface 810 includes a keyboard, keypad, mouse, trackball, trackpad, touchscreen, and/or cursor direction keys for communicating information and commands to Processor 802.

Processing circuitry 800 also includes Network Interface 812 coupled to Processor 802. Network Interface 812 allows processing circuitry 800 to communicate with Network 814, to which one or more other computer systems are connected. Network Interface 812 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 800 is configured to receive information through I/O Interface 810. The information received through I/O Interface 810 includes one or more of instructions, data, design rules, libraries of cells, and/or other parameters for processing by Processor 802. The information is transferred to Processor 802 via Bus 808. Processing circuitry 800 is configured to receive information related to a User Interface (UI) through I/O Interface 810. The information is stored in Non-Transitory, Computer-Readable Storage Medium 804 as UI 822.

In one or more embodiments, one or more Non-Transitory, Computer-Readable Storage Medium 804 having stored thereon Instructions 806 (in compressed or uncompressed form) that may be used to program a computer, processor, or other electronic device) to perform processes or methods described herein. The one or more Non-Transitory, Computer-Readable Storage Medium 804 include one or more of an electronic storage medium, a magnetic storage medium, an optical storage medium, a quantum storage medium, or the like.

For example, the Non-Transitory, Computer-Readable Storage Medium 804 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 804 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 804 stores Instructions 806 configured to cause Processor 802 to perform at least a portion of the processes and/or methods for performing cellular diagnostics. In one or more embodiments, Non-Transitory, Computer-Readable Storage Medium 804 also stores information, such as algorithm which facilitates performing at least a portion of the processes and/or methods for performing cellular diagnostics.

Accordingly, in at least one embodiment, Processor 802 executes Instructions 806 stored on the one or more Non-Transitory, Computer-Readable Storage Medium 804 to implement a device for performing cellular diagnostics. Processor 802 executes Instructions 806 to process Data 822, e.g., Measurement Results, Diagnostics, and the like, for presentation in a User Interface (UI) 820. Processor 802 is able to implement a Client 830, such as a CPE WAN Management Protocol (CWMP) Client. The Client 830 communicates with a Management Server via Network 814 using a specific communication protocol for providing the parameters of a cellular diagnostics data model. Processor 802 is able to receive a Diagnostics Request 832 that is stored in Non-Transitory, Computer-Readable Storage Medium. Processor 802 periodically or in response to the Diagnostics Request (or Command) 832 that prompts the Device to conduct a Quality Measurement Procedure 840 to obtain Measurement Results 842. Processor 802 is able to receive the request in response to a handover taking place, wherein a CPE changes attachment from a first Serving Cell to a second Serving Cell. Processor 802 is able to configure the Measurement Results according to a Cellular Diagnostics Data Model 844. Cellular Diagnostics Data Model 844 defines a structure for parameter definitions. Processor 802 obtains Measurement Results 842 that are then configured into parameters of the Cellular Diagnostic Data Model 844. The Cellular Diagnostics Data Model 844 for a cellular diagnostic measurement report provided to a Management Server via Network 814 is configured similar to the TR-181 Device: 2 Data Model, Amendment 12, and is able to keep consistency across the whole TR-181 design policy. The parameters definitions in the Cellular Diagnostics Data Model 844 is similar to the configuration of measurement results as specified in 3GPP TS 36.331. The parameters in the Cellular Diagnostics Data Model 844 include name and value pairs. Processor 802 configures the measurement results into the parameters of the Cellular Diagnostic Data Model by configuring the measurement results into a parameter name identifying the parameter and a value associated with the parameter name. The Cellular Diagnostics Data Model 844 enables the Measurement Results 842 to be configured as at least one of a physical Cell ID, a Reference Signal Received Power (RSRP) Result, or a Reference Signal Received Quality (RSRQ) Result respectively for a serving cell and at least one neighbor cell. Thus, the parameters associated with a cellular diagnostic test are defined as an extension to the Device.Cellular interface object defined in TR-181 Device: 2 Data Model. Processor 802 is able to receive Handover Instructions 846 and Cell Diagnostics 848 from a Management Server via Network 814 based on the Measurement Results 842 provided to the Management Server via Network 814. A Display 870 is provided where Processor 802 presents a User Interface (UI) 872 for rendering Data 874, e.g., Measurement Results, Diagnostics, and the like. Processor 802 is able to telecommunicate with a first base station of a first carrier and a second base station of a second carrier, wherein the Handover Instructions 846 prompts the Device to disconnect from a first serving cell and attach to a second serving cell, wherein the second serving cell is selected from a plurality of neighbor cells.

Embodiments described herein provide method that provides one or more advantages. According to at least one embodiment, modules featured in 3GPP specified measuring reports are able to be used by a Device to communicate via a common protocol with a Management Server. For example, according to one embodiment, Customer Premise Equipment (CPE) WAN Management Protocol (CWMP) is able to be used for Cellular Diagnostics by directly reusing existing modules featured in 3GPP specified measuring reports in TR-069 CWMP and Auto-Configuration Server (ACS). A carrier is able to make full usage of cellular environment information (e.g., representation from a Cell ID set) to calculate location of a Device and monitor movement of a Device. Cellular Diagnostics according to at least one embodiment reduces additional cost and additional battery usage by traditional GPS or similar components used for location features because location is able to be determined based on measurement results of predetermined parameters. For example, a Device, including Mobile Phones, Wi-Fi Routers, and the like, are able to be implemented as a TR-069 ACS Component. A Cellular Diagnostics method according to at least one embodiment addresses the network connectivity issue between a management server and Devices (e.g., CPEs, mobile phones, routers and the like) by creating a Cellular Diagnostics Data Model (including that obtained under 3GPP technical spec) and enabling the measurement results configured according to the Cellular Diagnostics Data Model to be utilized under a predetermined framework. In at least one embodiment, the framework is the CWMP framework, which includes CPE and ACS. Thus, the sharing of data between base stations and Devices enables trouble-shooting issues at the core network by the management server, e.g., ACS. A Cellular Diagnostics method according to at least one embodiment completes the missing diagnostics feature definition for a cellular context in TR-069 enabled components, along with a corresponding data scheme or Cellular Diagnostics Data Model that is compatible with TR-181 and 3GPP. The 3GPP measurement results are thus able to be used in a location calculation business practice.

An aspect of this description is directed to a method [1] for performing cellular diagnostics includes conducting, by a device, a quality measurement procedure to obtain measurement results associated with radio communication, wherein the device telecommunicates with at least one base station, configuring the measurement results into parameters of a Cellular Diagnostic Data Model, and providing, by the device, the parameters of the Cellular Diagnostic Data Model to a management server.

The method described in [1], further includes wherein the providing, by the device, the parameters of the Cellular Diagnostic Data Model to the management server includes providing the parameters of the Cellular Diagnostic Data Model to the management server for diagnosing the device or the at least one base station attached to by the device.

The method described in [1] to [2], wherein the device corresponds to a Customer Premise Equipment (CPE) and the management server corresponds to an Auto-Configuration Server (ACS), the method further including receiving, by the CPE, a command from the ACS to perform an action according to a determination based on the parameters of the Cellular Diagnostic Data Model.

The method described in [1] to [3], further including telecommunicating by the CPE with a first base station of a first carrier and a second base station of a second carrier, wherein the receiving the command further comprises receiving a command prompting the CPE to disconnect from a first serving cell and attach to a second serving cell, the second serving cell being selected from a plurality of neighbor cells, and wherein the first serving cell is for the first base station of the first carrier and the second serving cell is for the second base station of the second carrier.

The method described in [1] to [4], wherein the configuring the measurement results into the parameters of the Cellular Diagnostic Data Model includes configuring the measurement results into a parameter name identifying the parameter and a value associated with the parameter name, wherein the parameter name includes at least one of a physical Cell ID, a Reference Signal Received Power (RSRP) Result, or a Reference Signal Received Quality (RSRQ) Result respectively for a serving cell and at least one neighbor cell.

The method described in [1] to [5], wherein the device corresponds to a Customer Premise Equipment (CPE), the CPE including a Customer Premise Equipment (CPE) WAN Management Protocol (CWMP) client, the method further including configuring, by the CWMP client of the CPE, the measurement results into parameters of the Cellular Diagnostic Data Model.

The method described in [1] to [6], further including receiving a request from an Auto-Configuration Server (ACS), and upon receiving the request from the ACS, reading, by the CWMP client of the CPE, the measurement results from the quality measurement procedure and configuring, by the CWMP client of the CPE, the measurement results into parameters of the Cellular Diagnostic Data Model.

The method described in [1] to [7], wherein the receiving the request includes receiving the request in response to a handover taking place, wherein the CPE changes attachment from a first serving cell to a second serving cell.

An aspect of this description is directed to a device [9], including a memory storing computer-readable instructions, and a processor connected to the memory, wherein the processor is configured to execute the computer-readable instructions to perform operations to conduct a quality measurement procedure to obtain measurement results associated with radio communication, wherein the processor telecommunicates with at least one base station, configure the measurement results into parameters of a Cellular Diagnostic Data Model, and provide the parameters of the Cellular Diagnostic Data Model to a management server.

The device described in [9], wherein the parameters of the Cellular Diagnostic Data Model are useable by the management server to diagnose the device or the at least one base station attached to by the device.

The device described in [9] to [10], wherein the processor implements a Customer Premise Equipment (CPE) and the management server corresponds to an Auto-Configuration Server (ACS), and wherein the processor is further configured to receive, at the CPE, a command from the ACS to perform an action according to a determination based on the parameters of the Cellular Diagnostic Data Model.

The device described in [9] to [11], wherein the CPE telecommunicates with a first base station of a first carrier and a second base station of a second carrier, wherein the processor is further configured to receive the command by receiving a command prompting the CPE to disconnect from a first serving cell and attach to a second serving cell, the second serving cell being selected from a plurality of neighbor cells, and wherein the first serving cell is for the first base station of the first carrier and the second serving cell is for the second base station of the second carrier.

The device described in [9] to [12], wherein the processor is further configured to configure the measurement results into the parameters of the Cellular Diagnostic Data Model by configuring the measurement results into a parameter name identifying the parameter and a value associated with the parameter name, wherein the parameter name includes at least one of a physical Cell ID, a Reference Signal Received Power (RSRP) Result, or a Reference Signal Received Quality (RSRQ) Result respectively for a serving cell and at least one neighbor cell.

The device described in [9] to [13], wherein the processor implements a Customer Premise Equipment (CPE) that includes a Customer Premise Equipment (CPE) WAN Management Protocol (CWMP) client, and wherein the processor is further configured to configure, using the CWMP client of the CPE, the measurement results into parameters of the Cellular Diagnostic Data Model.

The device described in [9] to [14], wherein the processor is further configured to receive a request from an Auto-Configuration Server (ACS), and upon receiving the request from the ACS, read, using the CWMP client of the CPE, the measurement results from the quality measurement procedure and configure, using the CWMP client of the CPE, the measurement results into parameters of the Cellular Diagnostic Data Model.

The device described in [9] to [15], wherein the processor is further configured to receive the request by receiving the request in response to a handover taking place, wherein processor changes attachment of the CPE from a first serving cell to a second serving cell.

An aspect of this description is directed to a non-transitory computer-readable media having computer-readable instructions stored thereon [17}, which when executed by a processor causes the processor to perform operations including conducting, by a device, a quality measurement procedure to obtain measurement results associated with radio communication, wherein the device telecommunicates with at least one base station, configuring the measurement results into parameters of a Cellular Diagnostic Data Model, and providing, by the device, the parameters of the Cellular Diagnostic Data Model to a management server.

The non-transitory computer-readable media described in [17], wherein the providing, by the device, the parameters of the Cellular Diagnostic Data Model to the management server includes providing the parameters of the Cellular Diagnostic Data Model to the management server for diagnosing the device or the at least one base station attached to by the device.

The non-transitory computer-readable media described in to [18], wherein the device corresponds to a Customer Premise Equipment (CPE) and the management server corresponds to an Auto-Configuration Server (ACS), the operations further including receiving, by the CPE, a command from the ACS to perform an action according to a determination based on the parameters of the Cellular Diagnostic Data Model.

The non-transitory computer-readable media described in to [19], further including telecommunicating by the CPE with a first base station of a first carrier and a second base station of a second carrier, wherein the receiving the command further comprises receiving a command prompting the CPE to disconnect from a first serving cell and attach to a second serving cell, the second serving cell being selected from a plurality of neighbor cells, and wherein the first serving cell is for the first base station of the first carrier and the second serving cell is for the second base station of the second carrier.

The non-transitory computer-readable media described in to [20], wherein the configuring the measurement results into the parameters of the Cellular Diagnostic Data Model includes configuring the measurement results into a parameter name identifying the parameter and a value associated with the parameter name, wherein the parameter name includes at least one of a physical Cell ID, a Reference Signal Received Power (RSRP) Result, or a Reference Signal Received Quality (RSRQ) Result respectively for a serving cell and at least one neighbor cell.

The non-transitory computer-readable media described in to [21], wherein the device corresponds to a Customer Premise Equipment (CPE), the CPE including a Customer Premise Equipment (CPE) WAN Management Protocol (CWMP) client, the operations further including configuring, by the CWMP client of the CPE, the measurement results into parameters of the Cellular Diagnostic Data Model.

The non-transitory computer-readable media described in to [22], further including receiving a request from an Auto-Configuration Server (ACS), and upon receiving the request from the ACS, reading, by the CWMP client of the CPE, the measurement results from the quality measurement procedure and configuring, by the CWMP client of the CPE, the measurement results into parameters of the Cellular Diagnostic Data Model.

The non-transitory computer-readable media described in to [23], wherein the receiving the request includes receiving the request in response to a handover taking place, and wherein the CPE changes attachment from a first serving cell to a second serving cell. Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for performing cellular diagnostics, comprising:
conducting, by a device, a quality measurement procedure to obtain measurement results associated with radio communication, wherein the device telecommunicates with at least one base station;
configuring the measurement results into parameters of a Cellular Diagnostic Data Model; and
providing, by the device, the parameters of the Cellular Diagnostic Data Model to a management server.

2. The method of claim 1, wherein the providing, by the device, the parameters of the Cellular Diagnostic Data Model to the management server includes providing the parameters of the Cellular Diagnostic Data Model to the management server for diagnosing the device or the at least one base station attached to by the device.

3. The method of claim 1, wherein the device corresponds to a Customer Premise Equipment (CPE) and the management server corresponds to an Auto-Configuration Server (ACS);
the method further comprising:
receiving, by the CPE, a command from the ACS to perform an action according to a determination based on the parameters of the Cellular Diagnostic Data Model.

4. The method of claim 3, further comprising:
telecommunicating by the CPE with a first base station of a first carrier and a second base station of a second carrier;
wherein the receiving the command further comprises receiving the command prompting the CPE to disconnect from a first serving cell and attach to a second serving cell, the second serving cell being selected from a plurality of neighbor cells; and
wherein the first serving cell is for the first base station of the first carrier and the second serving cell is for the second base station of the second carrier.

5. The method of claim 1, wherein the configuring the measurement results into the parameters of the Cellular Diagnostic Data Model includes configuring the measurement results into a parameter name identifying the parameter and a value associated with the parameter name, wherein the parameter name includes at least one of a physical Cell ID, a Reference Signal Received Power (RSRP) Result, or a Reference Signal Received Quality (RSRQ) Result respectively for a serving cell and at least one neighbor cell.

6. The method of claim 1, wherein the device corresponds to a Customer Premise Equipment (CPE), the CPE including a Customer Premise Equipment (CPE) WAN Management Protocol (CWMP) client:
the method further comprising:
configuring, by the CWMP client of the CPE, the measurement results into parameters of the Cellular Diagnostic Data Model.

7. The method of claim 6, further comprising:
receiving a request from an Auto-Configuration Server (ACS); and
upon receiving the request from the ACS, reading, by the CWMP client of the CPE, the measurement results from the quality measurement procedure and configuring, by the CWMP client of the CPE, the measurement results into parameters of the Cellular Diagnostic Data Model.

8. The method of claim 7, wherein the receiving the request includes receiving the request in response to a handover taking place, and wherein the CPE changes attachment from a first serving cell to a second serving cell.

9. A Device, comprising:
a memory storing computer-readable instructions; and
a processor connected to the memory, wherein the processor is configured to execute the computer-readable instructions to perform operations to:
conduct a quality measurement procedure to obtain measurement results associated with radio communication, wherein the processor telecommunicates with at least one base station;
configure the measurement results into parameters of a Cellular Diagnostic Data Model; and
provide the parameters of the Cellular Diagnostic Data Model to a management server.

10. The Device of claim 9, wherein the parameters of the Cellular Diagnostic Data Model are useable by the management server to diagnose the device or the at least one base station attached to by the device.

11. The Device of claim 9, wherein the processor implements a Customer Premise Equipment (CPE) and the management server corresponds to an Auto-Configuration Server (ACS); and
wherein the processor is further configured to receive, at the CPE, a command from the ACS to perform an action according to a determination based on the parameters of the Cellular Diagnostic Data Model.

12. The Device of claim 11, wherein the CPE telecommunicates with a first base station of a first carrier and a second base station of a second carrier:
wherein the processor is further configured to receive the command by receiving the command prompting the CPE to disconnect from a first serving cell and attach to a second serving cell, the second serving cell being selected from a plurality of neighbor cells; and
wherein the first serving cell is for the first base station of the first carrier and the second serving cell is for the second base station of the second carrier.

13. The Device of claim 9, wherein the processor is further configured to configure the measurement results into the parameters of the Cellular Diagnostic Data Model by configuring the measurement results into a parameter name identifying the parameter and a value associated with the parameter name, wherein the parameter name includes at least one of a physical Cell ID, a Reference Signal Received Power (RSRP) Result, or a Reference Signal Received Quality (RSRQ) Result respectively for a serving cell and at least one neighbor cell.

14. The Device of claim 9, wherein the processor implements a Customer Premise Equipment (CPE) that includes a Customer Premise Equipment (CPE) WAN Management Protocol (CWMP) client; and
wherein the processor is further configured to configure, using the CWMP client of the CPE, the measurement results into parameters of the Cellular Diagnostic Data Model.

15. The Device of claim 14, wherein the processor is further configured to:
receive a request from an Auto-Configuration Server (ACS); and
upon receiving the request from the ACS, read, using the CWMP client of the CPE, the measurement results from the quality measurement procedure and configure, using the CWMP client of the CPE, the measurement results into parameters of the Cellular Diagnostic Data Model.

16. The Device of claim 15, wherein the processor is further configured to receive the request by receiving the request in response to a handover taking place, wherein processor changes attachment of the CPE from a first serving cell to a second serving cell.

17. A non-transitory computer-readable media having computer-readable instructions stored thereon, which when executed by a processor causes the processor to perform operations comprising:
conducting, by a device, a quality measurement procedure to obtain measurement results associated with radio communication, wherein the device telecommunicates with at least one base station;
configuring the measurement results into parameters of a Cellular Diagnostic Data Model; and
providing, by the device, the parameters of the Cellular Diagnostic Data Model to a management server.

18. The non-transitory computer-readable media of claim 17, wherein the providing, by the device, the parameters of the Cellular Diagnostic Data Model to the management server includes providing the parameters of the Cellular Diagnostic Data Model to the management server for diagnosing the device or the at least one base station attached to by the device.

19. The non-transitory computer-readable media of claim 17, wherein the device corresponds to a Customer Premise Equipment (CPE) and the management server corresponds to an Auto-Configuration Server (ACS):
the operations further comprising:
receiving, by the CPE, a command from the ACS to perform an action according to a determination based on the parameters of the Cellular Diagnostic Data Model.

20. The non-transitory computer-readable media of claim 19, further comprising:
telecommunicating by the CPE with a first base station of a first carrier and a second base station of a second carrier;
wherein the receiving the command further comprises receiving the command prompting the CPE to disconnect from a first serving cell and attach to a second serving cell, the second serving cell being selected from a plurality of neighbor cells; and
wherein the first serving cell is for the first base station of the first carrier and the second serving cell is for the second base station of the second carrier.
